(19) United States
(12) Patent Application Publication
(10) Pub. No.: US 2010/0039389 A1
(43) Pub. Date: Feb. 18, 2010

(54) DIGITAL PHOTO FRAME CAPABLE OF ADJUSTING DIGITAL IMAGE AND METHOD THEREOF

(75) Inventors: MING-FENG TSAI, Tu-Cheng (TW); TE-YUAN KUNG, Tu-Cheng (TW); CHENG-HAO CHOU, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/350,233

(22) Filed: Jan. 8, 2009

(30) Foreign Application Priority Data
Aug. 12, 2008 (CN) 200810303698.9

(51) Int. Cl. G06F 3/02; G06F 3/038

(52) U.S. Cl. 345/168; 345/204

(57) ABSTRACT

A method for adjusting images is provided. The method includes: acquiring a predetermined time interval; performing adjustment for a current property and displaying the image with different settings of the current property; receiving input signals; generating control signals corresponding to the input signals; upon the condition that the processor generates a skipping control signal, directly adjusting the next property according to the sequence table; upon the condition that the processor generates a selecting control signal, keeping of the current property, and adjusts the next property based of the image selected setting on the current property.

### TECHNICAL FIELD

The disclosure relates to a digital photo frame with image adjustment function and a image adjustment method thereof.

### DESCRIPTION OF RELATED ART

Digital photo frames are intended to conveniently display digital images without the need to print the digital images out. Currently, some digital photo frames have only simple input units, for example, a few buttons, and the buttons can only relay a few signals. These digital photo frames are limited to receiving user input just through those simple input units, that is, a user can only perform a few operations, and so adjusting how the digital photo frames display an image by those input units can be a complex process. Therefore, what is needed is a digital photo frame allowing simple button operations to adjust image properties.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart illustrating a method of adjusting properties of a current image according to user input in the digital photo frame of FIG. 1 in accordance with an exemplary embodiment.

### DETAILED DESCRIPTION OF EMBODIMENTS

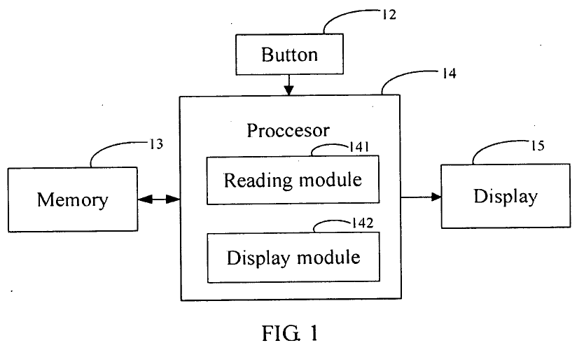

FIG. 1 is a block diagram of a hardware infrastructure of a digital photo frame in accordance with an exemplary embodiment. The digital photo frame includes at least a button 12, a memory 13, a processor 14, and a display 15.

The memory 13 is configured for storing images and a sequence table. Each image is associated with a plurality of image properties, such as brightness, contrast, and the like. The sequence table records an order of adjusting image properties. For example, in the exemplary embodiment, the order of adjusting image properties is set as brightness first then contrast. The memory 13 further stores different settings of each image's properties. Additionally, the memory 13 stores a predetermined time interval T1, the time interval T1 can be pre-set, and also can be manually defined by a user.

When the digital photo frame enters an adjustment mode to adjust an image displayed on the display 15, the digital photo frame obtains a default image property, namely the first image properties from the sequence table, and performs an adjustment on the default image properties according to user input.

The button 12 is configured for relaying input signals to the processor 14.

The processor 14, being connected with the memory 13 as well as the button 12 and the display 15, is configured for generating control signals in response to various input signals while the button 12 is pressed. In this embodiment, for example, when the button is clicked once, the processor 14 generates a skipping control signal; when the button is double clicked, the processor 14 generates a selecting control signal.

The processor 14 includes a reading module 141 and a display module 142. The reading module 141 is configured for obtaining images, image properties, and the sequence table from the memory 13. The display module 142 is configured for adjusting properties of the image according to the sequence table and control signals generated by the processor 14.

The display module 142 performs a current property adjustment to the image, and then goes on to the next property in the table until all the properties have been adjusted.

In the exemplary embodiment, for example, the current property is contrast, which includes settings of 20%, 40%, 60%, and 80%, and the next property is brightness. The display module 142 displays the image using various settings of the current property (contrast), for example, the display module 142 displays the image with contrast setting of 20%, then after an interval, with contrast setting of 40%, then after a second interval, with contrast setting of 60%, then after a third interval, with contrast setting of 80%, then after another interval, repeating the cycle until there is a control signal received or a predetermined time interval T1 expires.

If there is no control signal received during the interval T1, the display module 142 sets the property at a default setting and goes on to the next property in the table (brightness) and does the same again using various brightness settings.

If at any time a control signal initiated by the user is received during the interval T1, the currently property setting is kept and the next property in the table is applied and adjusted in the same manner. When the received control signal is a selecting control signal, the display module 142 keeps the current property setting (for example, 40%), and continues on to the next property. When the received control signal is a skipping control signal, the display module 142 skips adjustment for the current property (contrast), and directly adjusts the next property (brightness). Once all properties of the sequence table have been done, a final image for display is obtained that may be based on user selected settings, default settings, or a combination of both.

The digital photo frame can also provide a menu item for activating the digital photo frame to enter the image property adjustment mode.

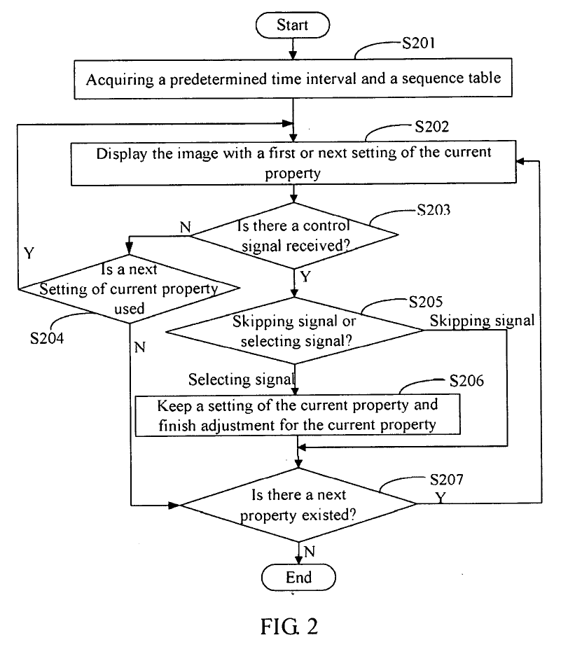

FIG. 2 is a flowchart illustrating a method of adjusting properties of a current image according to user input in the digital photo frame of FIG. 1 in accordance with an exemplary embodiment. In the flowchart, in the exemplary embodiment, the current property is contrast, and settings of contrast include 20%, 40%, 60%, and 80%, and the next property is brightness.

In step S201, after the image property adjustment mode is invoked in the digital photo frame through user selection of the corresponding menu item, the reading module 141 acquires the predetermined time interval T1 and a sequence table.

In step S202, the displaying module 142 displays the image using a first or next setting of the current property, then goes to step S203.

In step S203, the displaying module waits for a control signal in the time interval T1. If a control signal is received during time interval T1, go to step S205, if no control signal received during the interval T1, go to step S204.

In step S204, the displaying module checks if there is a next setting to use for the current property. If yes, repeat step S202, if not, go to step S207.

In step S205, the displaying module 142 further checks whether the received control signal is a skipping control signal or a selecting control signal. If the received control signal is a skipping control, the procedure goes to S207, if the received control signal is a selecting control signal, go to S206. In this exemplary embodiment, when the button 12 is clicked once, the processor 14 generates a skipping control signal; when the button 12 is double clicked, the processor 14 generates a selecting control signal.

In step S206, the display module 142 keeps a setting of the current property (contrast), for example, 40%, and the procedure goes to S207.

In step S207, the display module 142 determines whether there is a next property. If not, the current settings are kept and the image is displayed with the properties set, if yes, the next property is now taken as the current property and process goes to S202.

Additionally, when adjusting one of the image properties, the display module 142 displays information of the current property. For example, the information may include, but is not limited to, a name, settings of the current property. The display module 142 can also display the name of the next image property according to the sequence table.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A digital photo frame (DPF) for adjusting images, comprising:
a display;
a button for relaying input signals;
a memory for storing images, a predetermined time interval, a sequence table, and various properties of each image, wherein each of the properties is associated with a plurality of settings, and the sequence table records an order of adjusting image properties; and
a processor, being connected with the memory as well as the button and the display, for adjusting image and generating control signals according to input signals, wherein the control signals includes a skipping control signal, and a selecting control signal, the processor comprising:
a reading module configured for obtaining the predetermined time interval, the properties of an image, and the sequence table from the memory; and
a display module configured for adjusting the image properties according to the control signals and the sequence table, wherein upon the condition that the processor generates the skipping control signal, the display module directly adjusts next property in the sequence table; and upon the condition that the processor generates the selecting control signal, the display module keeps a setting of the current property, and adjusts the next property based on the image with the selected value of the current property.

2. The DPF as described in claim 1, wherein when the button is clicked once, the processor generates the skipping control signal; when the button is double clicked, the processor generates the selecting control signal;

3. The DPF as described in claim 1, wherein the sequence table is either pre-set or defined by a user.

4. The DPF as described in claim 1, wherein the predetermined time interval is either pre-set or defined by a user.

5. The DPF as described in claim 1, wherein the display module is further configured to control the display of the DPF to display information of the current image property and information of the next image property, wherein the information includes at least a name, and a value of the properties.

6. A method of adjusting image properties applied on a digital photo frame (DPF) which includes:
a button;
a memory; and
a display,
the method comprising:
acquiring a predetermined time interval from the memory;
displaying the image using various settings of the current property;
receiving input signals;
generating control signals corresponding to the input signals;
upon the condition that the processor generates a skipping control signal, directly adjusting the next property; upon the condition that the processor generates a selecting control signal, keeping a setting of the current property, and adjusts the next property based on the image selected setting of the current property.

7. The method as described in claim 6, further comprising: obtaining a sequence table from the memory, wherein the sequence table records the order of adjusting picture parameters.

8. The method as described in claim 6, wherein when performing adjustment for a property, display information of the property and information of next image property, the information comprises a name and a setting of the property.

9. The method as described in claim 6, wherein when the button is clicked once, the processor generates a skipping control signal; when the button is double clicked, the processor generates a selecting control signal.
